(19) United States
(12) Patent Application Publication
(10) Pub. No.: US 2007/0040775 A1
(43) Pub. Date: Feb. 22, 2007

(54) LIGHT QUANTITY CONTROL DEVICE AND LIGHT QUANTITY CONTROL METHOD AND ELECTRO PHOTOGRAPHIC DEVICE USING THE SAME

(75) Inventors: Kouhei HORISAKI, Fukuoka (JP); Toshihiko MITSUSE, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/464,544

(22) Filed: Aug. 15, 2006

(30) Foreign Application Priority Data
Aug. 18, 2005 (JP) 2005/237173
Aug. 29, 2005 (JP) 2005/247123

(51) Int. Cl. G09G 3/32

(52) U.S. Cl. 345/82

(57) ABSTRACT

The present invention provides a light quantity control device comprising organic EL elements 3a to 3n and a measuring unit 51 measuring cumulative number of light emitting (time) of the organic EL elements 3a to 3n, a nonvolatile memory 52 storing a driving preset value of the organic EL elements 3a to 3n based on the cumulative number of light emitting, a control means 31 updating the driving preset value based on the cumulative number of light emitting, the control means 31 including a rewritable memory 32 and accumulating the number of light emitting into the rewritable.

### BACKGROUND OF THE INVENTION

1. Field of the Invention

The present invention relates to a light quantity control device and a light quantity control method for controlling the light emitting quantity of light emitted from light emitting element (hereinafter the light emitting quantity of the light emitting element), especially the light quantity control device and light quantity control method for controlling the light emitting quantity of the light emitting element provided in an exposure device that is one of constituent elements of the electro photographic device, and the electro photographic device mounting the light quantity control device.

2. Description of the Related Art

The electro photographic device is a device which exposes a charged photoconductor in response to image information thus forming an electrostatic latent image, develops the electrostatic latent image with a toner, transfers and fixes by heating a toner image developed on the photoconductor to a recording paper thus obtaining an image. Here, as an exposure device which forms the electrostatic latent image on the photoconductor, there has been known the exposure device of a type which selectively drives respective light emitting elements of a light-emitting-element array so as to make the light emitting elements emit light and radiates the photoconductor, and the exposure device of a type which radiates irradiated light beams of laser diodes to the photoconductor by way of a rotary multiple-face mirror referred to as a polygon mirror.

In general, the electro photographic device which uses the exposure device including the light-emitting-element array in the light projecting part has no movable part such as the polygon mirror when the laser diodes are used and hence, such an electro photographic device acquires the high reliability. Further, since an optical system which guides the irradiated light from the laser diode to the photoconductor and a large optical space which becomes a path of light becomes unnecessary and hence, it is possible to miniaturize the device.

Here, as the light emitting element which constitutes the light-emitting-element array, an LED (light emitting diode), an electroluminescent element (hereinafter, an organic EL element) or the like is named. When the organic EL element is used, the irregularities of light quantity among the organic EL elements in the inside of the organic EL element array are large and hence, in the electro photographic device provided with the exposure device which uses the organic EL element array, there arises a drawback that an acquired image exhibits density irregularities.

Further, the organic EL element has the light quantity change characteristics attributed to the characteristics of an organic material that the light quantity is remarkably lowered along with a lapse of a time of light emitting. Accordingly, in the electro photographic device provided with the exposure device which uses the organic EL element, even when light quantities of the respective organic EL elements are adjusted within a range of light quantity irregularities of a certain level in an initial stage so that the device can be used at a level which does not influence an image, as the number of printing of electro photographs is increased, the respective organic EL elements differ from each other in the total time of light emitting and hence, the respective organic EL elements do not exhibit the uniform change of light quantity (lowering of light quantity) thus giving rise to drawbacks such as the generation of density irregularities or stripe irregularities of the image along with the laps of time.

Accordingly, as a countermeasure to cope with such a drawback, for example, in Japanese Patent Laid-Open 2002-361924, there has been proposed an exposure device which measures the number of light emitting of respective light emitting elements, and to make the numbers of light emitting of the respective light emitting elements as same as the number of light emitting of the light emitting element which exhibits the maximum number of light emitting, allows other respective light emitting elements to emit light during a non-exposure period (so-called dummy light emitting) thus making the numbers of light emitting of the respective light emitting elements equal whereby the light quantity changes of the respective light emitting elements are made uniform.

However, in the above-mentioned technique disclosed in Japanese Patent Laid-Open 2002-361924, the light emitting which is unnecessary in the original exposure is performed wastefully and hence, the change of light quantity (lowering of light quantity) of the organic EL element that is the light emitting element is accelerated thus giving rise to a drawback that the lifetime of the organic EL element and the exposure device using the organic EL element becomes extremely short.

Further, when the uniform light emitting condition is applied to all organic EL elements, the respective organic EL elements exhibit irregularities with respect to a light quantity at an initial stage. That is, the light emitting conditions of the organic EL elements differ from each other at a point of time of initial emission and hence, it is necessary to decrease the light quantity irregularities among the respective organic EL elements by adjusting time of light emitting, current values or the like at the time of emitting light one time for respective organic EL elements. Even when the exposure device is controlled under the conditions such that the numbers of light emitting of the respective organic EL emitting elements become equal, since the change of light quantity (lowering of light quantity) of the respective organic EL elements is not uniform corresponding to the numbers of light emitting and hence, there also arises the drawback that the light quantity irregularities among the organic EL elements are increased along with a lapse of time.

If the light emitting quantity of the light emitting element itself can be monitored, it is possible to detect the lowering of the light emitting quantity based on an output value thereof and to hold the light emitting quantity constant. However, in general, the comparatively large-scale hardware is required in order to accomplish monitoring in this manner, it has been difficult to realize the monitoring in a printing device requested to satisfy high efficiency and low cost.

### SUMMARY OF THE INVENTION

The present invention has been made under such circumstances, and it is an object of the present invention to provide an light quantity control device provided with a light quantity adjusting mechanism which makes light quantities of respective light emitting elements uniform at an initial stage and after a lapse of a predetermined time.

The present invention provides a light quantity control device, comprising an organic electroluminescence element, a measuring unit measuring cumulative number of light emitting or cumulative time of light emitting, a light quantity controller generating a driving preset value of the organic electroluminescence element based on the measured result of the measuring unit, a driving controller driving the organic electro luminescence element based on the driving preset value generated by the light quantity controller.

According to the present invention, it is possible to make the light quantities of the respective organic EL elements of the light-emitting-element array uniform at the initial stage and after a lapse of certain time.

### BRIEF DESCRIPTION OF THE DRAWINGS

FIG. 1 is a front view showing a light-projecting opening portion of an exposure device to which the light quantity control device of embodiment 1 of the invention is applied;

FIG. 2 is a cross-sectional view taken along a line A showing the cross-sectional constitution of the light-projecting opening portion of the exposure device to which the light quantity control device of the embodiment 1 of the invention is applied;

FIG. 3 is a cross-sectional view showing the detailed constitution of an organic EL element according to the embodiment 1 of the invention;

FIG. 4 is a conceptual view showing one example of an electro photographic device provided with the exposure device according to the embodiment 1 of the invention;

FIG. 5 is a block diagram showing the constitution of a light quantity controller according to an embodiment 1 of the invention;

FIG. 6 (a) is a view for explaining a stored content of a rewritable memory according to the embodiment 1 of the invention;

FIG. 6 (b) is a view for explaining a stored content of a rewritable memory according to the embodiment 1 of the invention;

FIG. 7 is a time chart for explaining a cumulating operation of the number of light emitting to the rewritable memory of a controlling means according to the embodiment 1 of the invention;

FIG. 8 is a view for explaining the relationship between a light quantity change characteristics and a light quantity adjustment timing with respect to the cumulative time of light emitting of the organic EL elements and an initial value which is set by the rewritable memory according to the embodiment 1 of the invention; and

FIG. 9 is a block diagram showing periphery parts of the light quantity adjusting mechanism according to an embodiment 1 of the invention;

FIG. 10 is a flowchart showing the flow of the light quantity adjustment according to the embodiment 1 of the invention;

FIG. 11 (a) is a characteristic chart showing a relationship between cumulative number of light emitting and the light quantity of the light emitting in case of driving the organic EL element at a predetermined current value according to the embodiment 1 of the invention;

FIG. 11 (b) is a characteristic chart showing a relationship between cumulative number of light emitting and the driving current value in case of driving the organic EL element at a predetermined brightness value according to the embodiment 1 of the invention;

FIG. 12 is a explanation chart showing a relationship between cumulative number of light emitting of the organic EL elements and the driving current value;

FIG. 13 is an operation flowchart of the light quantity adjusting mechanism according to the embodiment 1 of the invention; and

FIG. 14 is a block chart showing constitution of the light quantity control device according to the embodiment 2 of the invention.

### DESCRIPTION OF THE PREFERRED EMBODIMENTS

The light quantity control device of this invention comprises an organic EL, a measuring unit measuring cumulative number of light emitting or cumulative time of light emitting, a light quantity controller generating a driving preset value of the organic EL element based on the measured result of the measuring unit, a driving controller driving the organic EL element based on the driving preset value generated by the light quantity controller. Hereby, it is possible to easily perform the light quantity control of an emitting light quantity of the organic EL element without directly monitoring the light emitting quantity by a sensor or the like, the uniform light emitting quantity of the organic EL element can be obtained even with a lapse of time. Particularly, by using the light quantity control device of the present invention as an exposure device of an image forming apparatus, it is possible to provide a low-cost-and-stable image forming apparatus.

Also, the invention comprises a nonvolatile memory, wherein the driving preset value corresponded to the cumulative number of light emitting or the cumulative time of light emitting in case of driving the organic EL element at a predetermined brightness value, is stored in the nonvolatile memory. Hence, it is possible to obtain the driving preset value recovering the light emitting quantity of the organic EL element only by accessing the nonvolatile memory.

Also, the invention is wherein the driving preset value is any one of a current value, a voltage value, a ON duty ratio of a current and a ON duty ratio of a voltage. Hereby, by simple hardware construction, it is possible to keep the light emitting quantity of the organic EL element constant.

Also, this invention is wherein the measuring unit includes a rewritable memory, and a controller accumulating number of light emitting or time of light emitting to the rewritable memory based on a light emitting data of the organic electroluminescence element and stored values read out from the rewritable memory. Hereby, it is possible to measure the cumulative number of light emitting or the cumulative time of light emitting of the organic EL constituting light emitting array without the large-scale count circuit.

Also, this invention is wherein the measuring unit includes a rewritable memory storing initial values devoting to accumulate time of light emitting or number of light emitting of the organic electroluminescence element, a controller accumulating number of light emitting or time of light emitting to the rewritable memory based on an light emitting data of the organic electroluminescence element and stored values read out from the rewritable memory, a detector detecting that the number of light emitting or the time of light emitting which the controller writes in the rewritable memory arrives at predetermined values, and an initializing unit initializing the stored values. Hereby, the number of light emitting or the time of light emitting of the organic EL elements is cumulatively stored, and when the stored value arrives at the predetermined value, a light emitting condition (a time of light emitting, a drive current value, a drive voltage value) of the organic EL element is adjusted to maintain the light quantity such that a fixed light quantity level including the initial light quantity is maintained. Along with such an adjustment, each time the arrival of the stored value to the predetermined value is detected, the stored value of the rewritable memory is initialized to the initial value. Accordingly, it is possible to effectively adjust the light quantity of each organic EL element to the fixed light quantity level including the initial light quantity at an initial stage and after a lapse of a predetermined time.

Also, the invention is wherein the controller controls not to write in the rewritable memory in case such that the light emitting data is a logical value which brings the organic electroluminescence element into a non-light-emitting state. Hereby, it is possible to reduce the number of the operations.

Also, the invention is wherein the rewritable memory is a memory exhibiting a low guarantee value of the number of writing. Hereby, the memory having no need to comprise the back-up power supply such as EEPROM or Flash memory can be used therefore it is possible to reduce the cost.

Also, the invention is wherein the controller, in synchronism with the light emitting data, reads out the stored values from the rewritable memory, and performs an operation to write the updated number of light emitting or the updated time of light emitting to the rewritable memory. Hereby, it is possible to certainly accumulate the number of light emitting or time of light emitting.

Also, the invention is wherein the rewritable memory means is a high-speed random accessible memory. Hereby, even if the number of the organic EL elements to be managed is large, it is possible to implement at low-cost.

Also, the invention is wherein a memory region of each address of the rewritable memory is constituted of a predetermined bit length, and the detector determines whether the number of light emitting or the time of light emitting arrives at the predetermined value or not based on a logic value of a specified bit in the predetermined bit length. Hereby, it is possible to detect that time the light emitting quantity of the organic EL element should be adjusted have been reached.

Also, the invention is comprising a light quantity adjuster, wherein the light quantity adjuster stores initial values showing timing of initial light quantity adjustment into the rewritable memory based on light quantity change characteristics of the organic EL element, and obtains initial values which are necessary for the next light quantity adjustment based on the light quantity change characteristics, and the initial values are supplied to the initializing unit as the predetermined initial values. Hereby, it is possible to adjust the light emitting quantity of the organic EL element by simple construction.

Also, the invention is wherein the light quantity adjuster generates light quantity adjusting data for adjusting light quantities of the organic electroluminescence element to predetermined values and the detector holds and outputs the information in which the detector detects that the light quantities arrive at the predetermined values until the generation of the light quantity adjusting data is completed. Hereby, it is possible to certainly adjust the light emitting quantity of the organic EL element.

Also, the invention is wherein the light quantity adjuster performs the generation of the light quantity adjusting data within a non-light emitting period. Hereby, it is possible to adjust the light emitting quantity of the organic EL element without setting a specific period.

The electro photographic device of the invention comprises a photoconductor, a charging device which charges a surface of the photoconductor, an exposure device which exposes the charged surface of the photoconductor in response to image information thus forming an electrostatic latent image, a developing unit which visualizes the electrostatic latent image with toner thus forming a toner image, and a light quantity control device, controlling the before mentioned exposure device. Hereby it is possible to provide the electro photographic device of constantly high quality.

The light quantity control method comprising the steps of obtaining the relationship between cumulative number of light emitting or cumulative time of light emitting and a driving preset values in case of driving the organic electroluminescence element at a predetermined brightness value, measuring cumulative light emitting count or the cumulative time of light emitting of driving the organic electroluminescence element, generating a driving preset value of the organic electroluminescence element based on the measured result, and driving the organic electroluminescence element based on the driving preset value. Hereby, it is possible to make the emitting light quantity of each organic EL element to the fixed light quantity level including the initial light quantity uniform at an initial stage and after the light emitting is carried out in long period.

Preferred embodiments of the light quantity adjusting mechanism which are provided to an exposure device according to the present invention are explained in detail hereinafter in conjunction with drawings.

### Embodiment 1

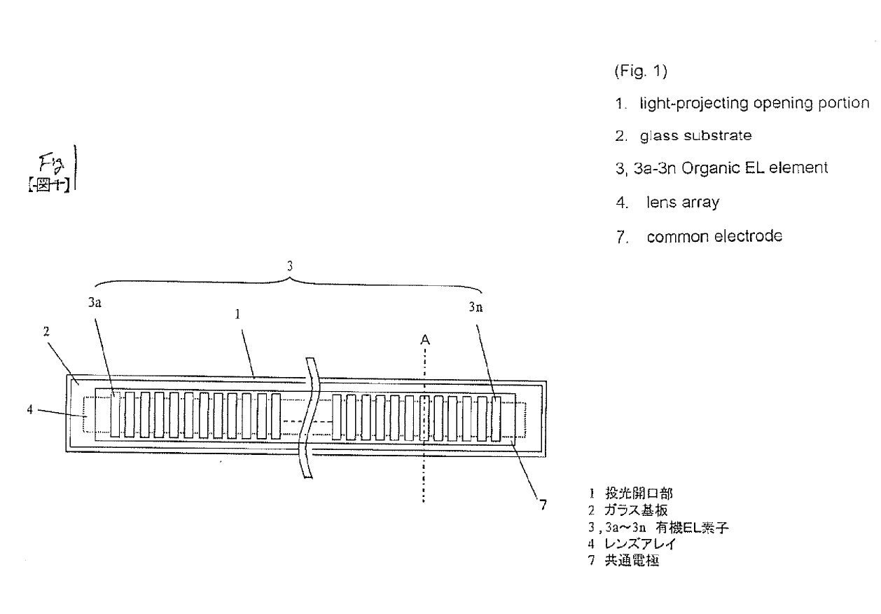

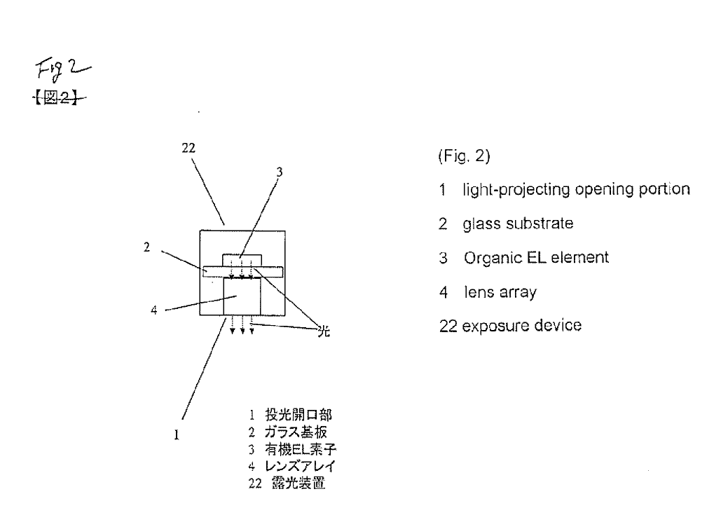

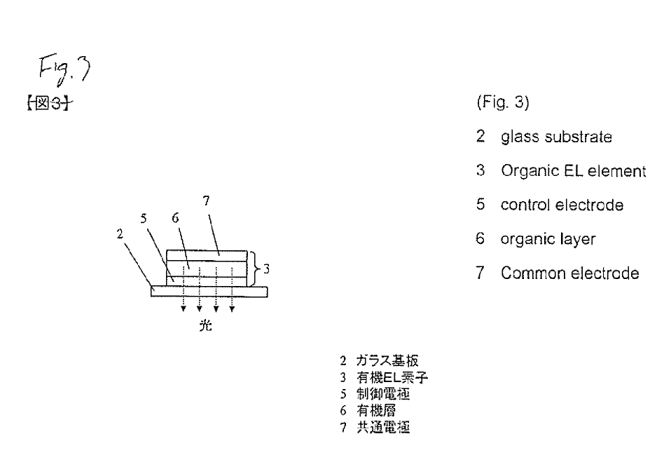

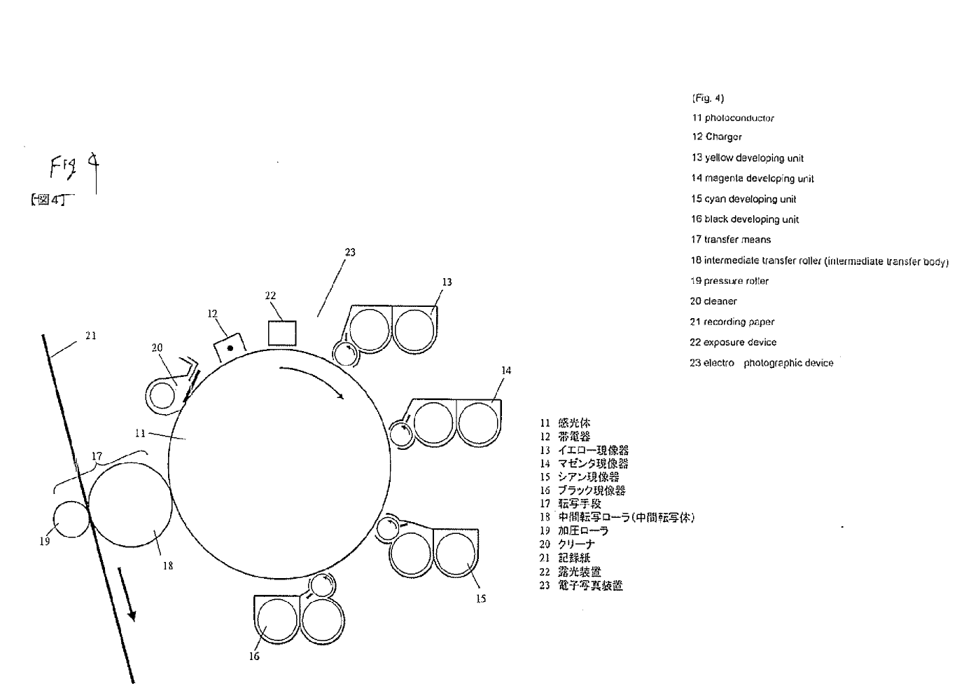

FIG. 1 is a front view showing a light-projecting opening portion of an exposure device to which the light quantity control device of embodiment 1 is applied. FIG. 2 is a cross-sectional view taken along a line A showing the cross-sectional constitution of the light-projecting opening portion of the exposure device to which the light quantity control device of the embodiment 1 is applied. FIG. 3 is a cross-sectional view showing the detailed constitution of an organic EL element according to the embodiment 1. FIG. 4 is a conceptual view showing one example of an electro photographic device provided with the exposure device according to the embodiment 1.

In FIG. 1, numeral 22 is an exposure device. Numeral 1 indicates a light-projecting opening portion of the exposure device 22 which opens in a rectangular shape. On an approximately center of an inner side wall of the light-projecting opening portion 1, a transparent glass substrate 2 is fixedly supported in a state that the glass substrate 2 closes the light-projecting opening portion 1. On one-side surface (a paper-surface-side surface in FIG. 1) of the glass substrate 2 which faces an inner depth side of the opening portion 1, a large number of organic EL elements 3a to 3n which constitute a light-emitting-element array are arranged at a suitable interval in the longitudinal direction of the opening portion 1 (Hereafter, in case that it is not necessary to distinguish from individual organic EL element, the organic EL element is described like “organic EL element 3”.)

Further, on one-side surface (a paper-back-surface-side in FIG. 1) of the glass substrate 2 which faces the outside of the light-projecting opening portion 1, a lens array 4 is arranged in a state that the lens array 4 strides over all organic EL elements 3a to 3n.

To be more specific, as shown in detail in FIG. 3, organic EL elements 3a to 3n are formed of an organic EL element in which a transparent control electrode 5 which is made of a material such as ITO is formed on the glass substrate 2, an organic layer 6 which is made of an organic material is formed on the control electrode 5, and a common electrode 7 which is made of Al or the like is formed on the organic layer 6. Here, the common electrode 7 also performs a function of a reflector.

Accordingly, although not shown in the organic EL elements 3a to 3n shown in FIG. 2, the organic EL elements 3a to 3n includes the common electrode 7. When a large number of organic EL elements 3a to 3n are arranged in an array state, the common electrode 7 constitutes a common electrode which is continuously brought into contact with the upper sides of the respective organic layers 6 of the organic EL elements 3a to 3n.

That is, the organic EL elements 3a to 3n shown in FIG. 1 are constituted of the control electrodes 5 which are arranged on the glass substrate 2 at a suitable interval, the organic layers 6 which are mounted on the respective control electrodes 5, and the common electrode 7 which is formed to be in continuous contact with upper sides of the respective organic layers 6.

Usually, each one of the organic EL elements 3a to 3n constitutes a light source for exposure of one pixel. For example, when a width of the exposure device in the longitudinal direction of the light emitting element is 210 mm (corresponding to a width of an A4-size paper), approximately 5000 light emitting elements 3 are arranged in the exposure device 22 having resolution of 600 dpi.

The light emitting operation is schematically explained. When a predetermined voltage is applied between the control electrode 5 and the common electrode 7 so as to allow an electric current to flow in the organic layer 6, the organic layer 6 is excited and an energy which is generated when the organic layer 6 returns to a ground state from the excited state is discharged as light. The common electrode 7 functions as a reflector and hence, the light which is emitted from the organic layer 6 mainly passes through the transparent control electrode 5 and the glass substrate 2 and, as shown in FIG. 2, is discharged to the outside from the light-projecting opening portion 1 by way of the lens array 4.

On the outside of the light-projecting opening portion 1, as shown in FIG. 4, a photoconductor 11 of the electro photographic device is arranged. That is, while the organic EL elements 3a to 3n are individually subjected to a light emitting control of light emitting and a non-light emitting in accordance with logic values of respective bits of image data, the lights emitted from the organic EL elements 3a to 3n are focused on the photoconductor 11 of the electro photographic device by the lens array 4 and hence, an electrostatic latent image is formed on the photoconductor 11.

In the electro photographic device shown in FIG. 4, toner images of four colors consisting of yellow, magenta, cyan and black are sequentially formed on the photoconductor 11 thus forming a full color image on the photoconductor 11 and, thereafter, the full color image is transferred to a recording paper 21. With respect to the order of colors in the formation of the full color image is set such that for instant the first color is yellow, the second color is magenta, the third color is cyan and the fourth color is black.

In FIG. 4, the photoconductor 11 is a dram-shaped rotary body provided with a photoconductive layer made of an organic-based material or an inorganic-based material such as amorphous Si on a conductive base body. A charger 12 is arranged to face the photoconductor 11. The charger 12 is a means which charges the photoconductor 11 with a uniform potential, wherein a well-known corona charger (a corotron charger, a scorotron charger) is used as such a charger 12.

Further, along the photoconductor 11, the exposure device 22, an yellow developing unit 13, a magenta developing unit 14, a cyan developing unit 15, a black developing unit 16, a transfer means 17 and a cleaner 20 are arranged starting from the charger 12 toward a downstream side of the rotational direction of the photoconductor 11.

The exposure device 22 is arranged in a state that the light-projecting opening portion 1 shown in FIG. 1 is directed to a surface of the photoconductor 11. The exposure device 22, after the surface of the photoconductor 11 is charged with the uniform potential by the charger 12, selectively emits light to the respective organic EL elements 3a to 3n provided in the exposure device corresponding to the light emitting data (image data) thus forming the electrostatic latent image corresponding to the image data on the surface of the photoconductor 11.

The yellow developing unit 13, the magenta developing unit 14, the cyan developing unit 15 and the black developing unit 16 respectively develop the electrostatic latent image formed on the photoconductor 11 using toners of respective colors in the inside of the developing units thus forming toner images of respective colors on the photoconductor 11.

The transfer means 17 is constituted of an intermediate transfer roller (intermediate transfer body 18) and a pressure roller 19 which pushes the recording paper 21 to the intermediate transfer roller 18. Due to such a constitution, the toner images on the photoconductor 11 are transferred to the recording paper 21.

The cleaner 20 is a cleaning means which, after the toner images are transferred to the recording paper 21 by the transfer means 17, collects the toner remaining on the photoconductor 11.

Image forming steps of the electro photographic device 23 having the above-mentioned constitution is briefly explained. First of all, the surface of the photoconductor 11 is charged with the uniform potential (for example, −700V) by the charger 12. Thereafter, corresponding to the light emitting data (image data) of yellow which is the first color, the respective organic EL elements 3a to 3n (Referring to FIG. 1) of the exposure device 22 selectively emit light, and surface potentials of the exposed parts of the photoconductor 11 corresponding to light emitting points are lowered (for example, −100 V).

Accordingly, on the photoconductor 11, the electrostatic latent image is formed due to a potential difference between −700V and −100V. Then, when a predetermined voltage (for example, −300V) is applied to a developing roller (a toner layer forming portion for developing) of the yellow developing unit 13, due to an electric field which works between the photoconductor 11 and the developing roller, the toner selectively adheres to the portions of the photoconductor 11 exposed by the exposure device 1 from the developing roller so that the yellow tone image is formed on the photoconductor 11.

Hereinafter, the respective toner images of magenta which is the second color, cyan which is the third color and black which is the fourth color are sequentially formed on the photoconductor 11 using the developing units (14 to 16) of respective colors thus forming the full-color toner image on the photoconductor 11. Thereafter, the toner image which is formed on the photoconductor 11 is collectively transferred to the recording paper 21 by the transfer means 17.

The recording paper 21 to which the toner image is transferred by the transfer means 17 is fixed by heating using a fixing unit not shown in the drawing Thereafter, the residual toner on the photoconductor 11 which finishes the transfer of the full color toner image is removed by the cleaner 20.

Here, FIG. 4 shows a constitutional example in which the toner image is collectively transferred to the recording paper 21 by way of the intermediate transfer roller 18. However, the toner image may be directly collectively transferred to the recording paper 21. With respect to both of the transfer from the photoconductor 11 to the intermediate transfer roller 18 and the transfer from the intermediate transfer roller 18 to the recording paper 21, either one of the transfer using an electric field and the transfer using pressure (offset transfer) can be used.

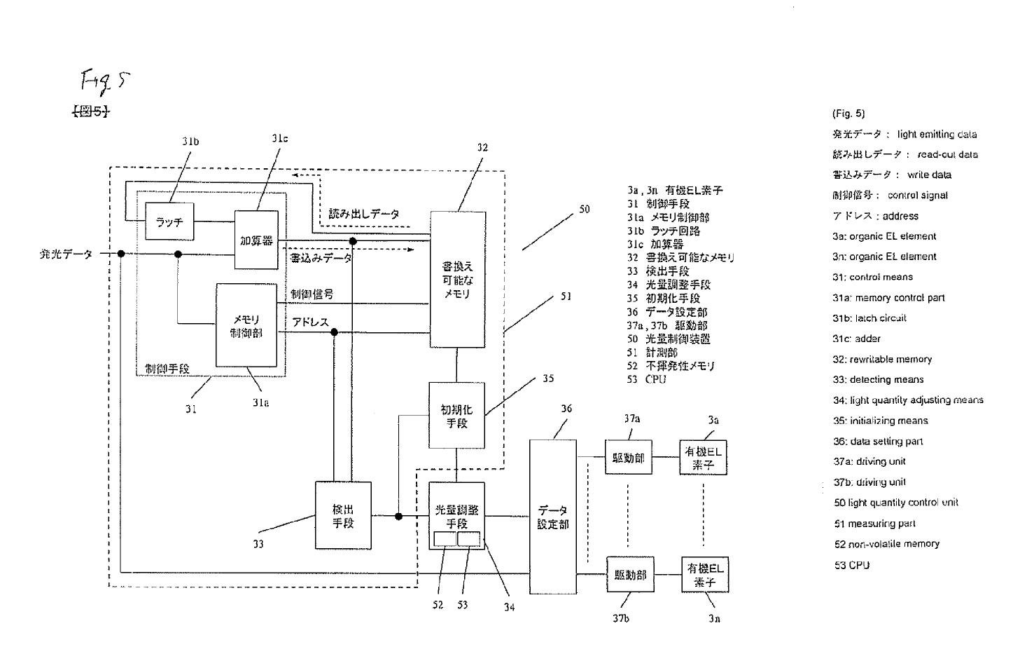

Here, the exposure device 22 shown in FIG. 4 includes the light quantity adjusting mechanism which individually adjusts respective light quantities of the organic EL elements 3a to 3n which are arranged in an array. Hereinafter, the light quantity adjusting mechanism which the exposure device 50 shown in FIG. 1 includes is explained in conjunction with FIG. 5 to FIG. 8. FIG. 5 is a block diagram showing the constitution of a light quantity control device according to an embodiment 1 of the present invention. Although it is explained in the embodiment 1 that the light quantity control device 50 is implemented in already mentioned exposure device 22 (Referring to FIG. 4), it is also possible to provide the light quantity control device 50 outside the exposure device 22.)

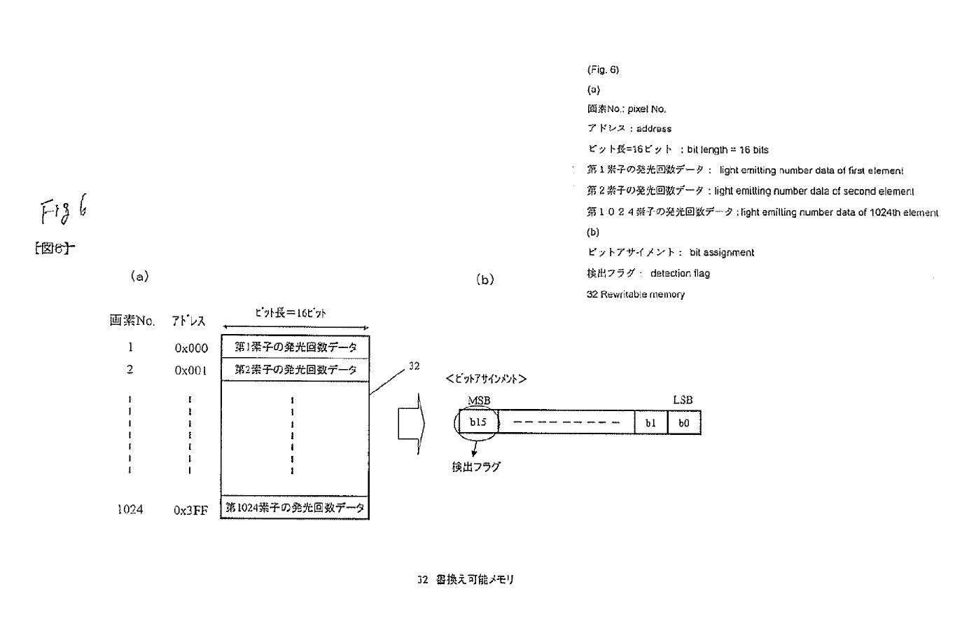

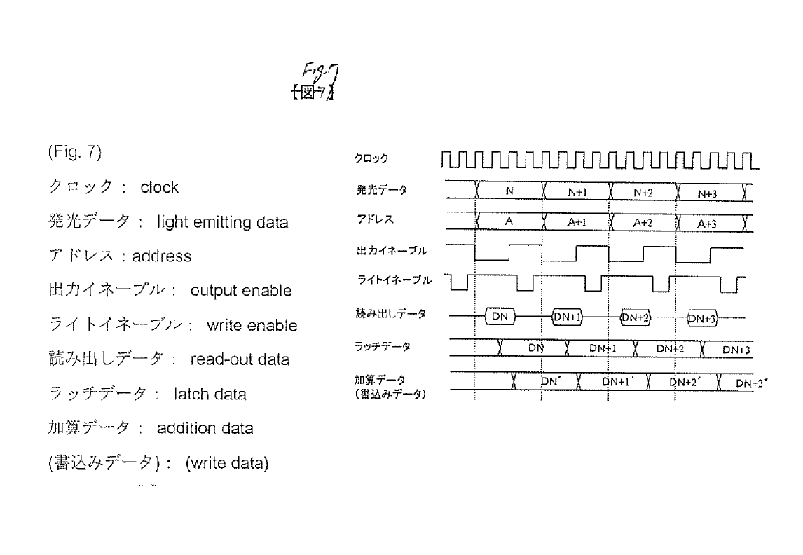

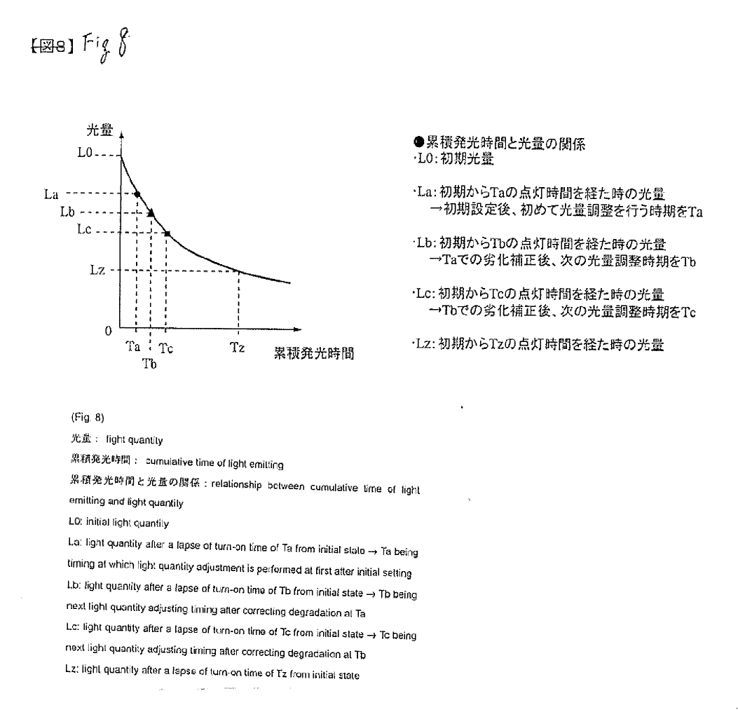

FIG. 6 (a), FIG. 6(b) is a view for explaining a stored content of a rewritable memory 32 of the embodiment 1 of this invention. FIG. 7 is a time chart for explaining a cumulating operation of the number of light emitting to the rewritable memory 32 of a control means 31 of the embodiment 1 of this invention. 5. FIG. 8 is a view for explaining the relationship between a light quantity change characteristics and a light quantity adjusting timing with respect to the cumulative time of light emitting of the organic EL element 3 of the embodiment 1 of this invention and an initial value which is set in the rewritable memory.

As shown in FIG. 5, the light quantity control device 50 individually adjusts the respective light quantities of the organic EL elements 3a to 3n which are arranged in an array includes a measuring unit 51 constituted of a control means 31, a rewritable memory (memory) 32, a detecting means 33, and a initializing means 35, a light quantity adjusting means 34, a data setting part 36, and driving unit 37a to 37n which are provided in the 1 to 1 relationship with the organic EL elements 3a to 3n. The control means 31 includes a memory control part 31a, a latch circuit 31b and an adder 31c. Also, the light quantity adjusting means 34 comprises at least non-volatile memory 52 (not shown) and CPU 53. Detailed explanation with regard to date stored in this non-volatile memory 52 is described below.

The light quantity adjusting method of the organic EL elements 3a to 3n can be roughly classified into two methods. One method is a PWM control which controls time of light emitting per one light emitting (that is, ON duty of driving current or voltage in driving the organic EL elements 3) and another method is a PAM control which controls current values per one light emitting. In the organic EL elements 3 which use the organic EL material, a method which drives the organic EL elements 3 by constant current driving and adjusts the drive current values for respective light emitting elements is mainly used. Of course, it is allowed to drive the organic EL elements 3 by controlling voltage values, instead of the current values. In the light quantity adjusting method according to the present invention explained hereinafter is applicable to both of the PWM control and the PAM control.

In FIG. 5, the light emitting data of the external input is formed of a row of bits which designates the light emitting and the non-light emitting of the organic EL elements 3a to 3n arranged in an array for respective light emitting elements and is constituted of bits corresponding to the number of organic EL elements 3a to 3n. Time for performing the light emitting control of the light emitting and the non-light emitting with respect to all organic EL elements 3a to 3n to 3n is time for exposing the photoconductor 11 by an amount corresponding to 1 line, and the respective corresponding bits of the light emitting data are sequentially inputted for every one element within this exposure time.

That is, the light emitting data of the external input is formed of scanning data for 1 line of the photoconductor 11, and the organic EL elements 3a to 3n which are arranged in an array are controlled as follows. That is, within the time that 1 line amount of the photoconductor 11 is exposed, the respective elements ranging from 3a to 3n are controlled into a light emitting state and a non-light emitting state sequentially for every 1 element in accordance with corresponding bit. For example, when the bit of the light emitting data is “1”, the corresponding organic EL elements 3a to 3n is driven into the light emitting state, while when such a bit is “0”, the corresponding organic EL elements 3a to 3n assumes the non-light emitting state. By repeating this exposure operation for every 1 line of the photoconductor 11, the above-mentioned electrostatic latent image is formed on the photoconductor 11.

The light emitting data is inputted to the light quantity control 50. More concretely, a memory control part 31a, an adder 31c in the inside of a control means 31 and a data setting part 36.

As described above, the organic EL elements 3a to 3n are driven into the light emitting state when the corresponding bit of the light emitting data is “1” and hence, the number of inputting of the bit “1” indicates the number of light emitting of the corresponding organic EL elements 3a to 3n.

Accordingly, the control means 31 counts the number of light emitting of the individual organic EL elements 3a to 3n for every light emitting data which is constituted of the corresponding bit, that is, for every 1-line scanning of the photoconductor 11 with respect to all organic EL elements 3a to 3n; and stores the counted numbers of light emitting to the rewritable memory 32. In the rewritable memory means 32; as shown in FIG. 6(a), an address having memory region of a predetermined number of bits is allocated for every light emitting element. In FIG. 6(a), as an example, a case in which the number of organic EL elements 3a to 3n is 1024 and the memory region of each address is constituted of 16 bits is shown. That is, in each address of the rewritable memory 32; the light emitting number data having a 16 bit length is stored. Here, although an initial value is preliminarily set in each address of the memory means 32, contents and a setting method of the initial value are explained later.

In the memory control part 31a, each time the corresponding bit of the light emitting data is inputted, the memory control part 31a generates the corresponding “address” of the rewritable memory 32 and “control signals” which control operations to write data into “address” or to read data from “address” and supplies the address and the control signals to the rewritable memory 32. That is, “control signals” are constituted of a write enable signal and a read enable (output enable) signal.

When “control signal” is the output enable signal, the read data (light emitting number data immediately before light emitting element) of the rewritable memory 32 is held by the latch circuit 31b. Each time the corresponding bit of the light emitting data is inputted, the adder 31c adds a logic value of the corresponding bit and the light emitting number data immediately before the organic EL element 3 which the latch circuit 31b holds and outputs. On the other hand, when “control signal” is the write enable signal, an addition result constitutes written data to the rewritable memory 32.

In this case, when the corresponding bit of the light emitting data is “1”, the written data becomes updated light emitting number data which is generated by adding “+1” to the number of light emitting immediately before the organic EL element 3, when the corresponding bit of the light emitting data is “0”, the written data becomes non-updated light emitting number data which is directly the number of light emitting immediately before the organic EL element 3 (that is, not incremented).

The updating operation of the number of light emitting by the control means 31 is specifically explained in conjunction with FIG. 7. In FIG. 7, as the light emitting data, the data bit ranging from the data bit N which corresponds to the Nth element of the organic EL elements and the data bit N+3 which corresponds to the (N+3) element of the organic EL elements 3 are indicated, and A to A+3 are indicated as addresses of the rewritable memory 32 which correspond to the data bits.

The memory control part 31a changes over the address to the rewritable memory 32 to the address A at the time of transmitting light emitting data N for the Nth element and, at the same time, changes over the output enable signal to the rewritable memory 32 to an active state (for example, “L” level) and reads out the light emitting number data DN of the Nth element from the rewritable memory 32. The read-out light emitting number data DN of the Nth element is held by the latch circuit 31b at predetermined timing.

The adder 31c adds the light emitting number data DN of the Nth element held by the latch circuit 31b and the light emitting data N to the Nth element at this point of time and this added value constitutes written data DN′ to the rewritable memory 32. The memory control part 31a writes the written data DN′ which the adder 31c outputs to the address N of the rewritable memory 32 at the timing of rising of the write enable signal.

Accordingly, when the light emitting data N to the Nth element is at the “1” level, the number of light emitting which is obtained by adding +1 to the number of light emitting up to the preceding time is stored in the address N of the rewritable memory 32, while when the light emitting data N to the Nth element is at the “0” level, the number of light emitting up to the preceding time is directly stored in the address N of the rewritable memory 32 without being updated. With respect to other organic EL element (such as N+1 in FIG. 7), in the same manner, the light emitting number data which corresponds to the logic value of the light emitting data to the element is updated to the predetermined address of the rewritable memory 32.

In this manner, due to the control means 31, the data reading operation and the data writing operation of the memory means 32 are executed in real time corresponding to each bit in the light emitting data for every line which is sequentially supplied, and the rewritable memory means 32 operates like a counter for every address and hence, the rewritable memory 32 can accurately cumulatively store the number of light emitting of the respective organ EL elements 3. The controlling means 32, in synchronism with the light emitting data, reads out the stored values from the rewritable memory 32, and performs an operation to write the updated number of light emitting or the updated time of light emitting to the rewritable memory. Accordingly, for example, by using a memory such as a SRAM which can perform the high-speed random access as the rewritable memory means, it is possible to facilitate the counting of the number of light emitting in real time in this manner.

Here, when the organ EL element 3 assumes the non-light emitting state, the number of light emitting is not changed. In this case, the data writing to the rewritable memory 32 may not be performed. To be more specific, the memory control part 31a controls ON/OFF of the write enable signal to the rewritable memory 32 corresponding to logic value of the light emitting data. That is, when the light emitting data to the element is “0”, the write enable signal is not made active, while when the light emitting data to the element is “1”, the write enable signal is made active. Due to such an operation, it is possible to store only the updated light emitting data of each element to the rewritable memory 32. Like this, in case that the light emitting data is a logical value which brings the organic EL element 3 into a non-light-emitting state, the controlling means 31 can control not to write in the rewritable memory 32. Hereby, it is possible to use a memory exhibiting a low guarantee value of the number of writing as the rewritable memory 32.

Further, depending on a condition such as the slow transfer frequency of the light emitting data or the provision of a plurality of memories, it is also possible to use a non-volatile memory such as an EEPROM or a flash memory. Accordingly, by controlling the presence or non-presence of the writing of data to the memory corresponding to the logic value of the light emitting data bit (corresponding bit) to the each organic EL element 3 as mentioned above, a memory usable period can be prolonged by reducing the access number thus the memory means 32 is advantageous with respect to the data holding property and the reduction of cost.

Next, the detecting means 33 detects the organic EL element 3 whose number of light emitting reaches the predetermined number based on the “address” which the memory control part 31a generates and the “written data” which the adder 31c outputs. To be more specific, the “written data” which the adder 31c outputs, in the example explained in conjunction with FIG. 6(a), the 16 bit length. As shown in FIG. 6(b), using an uppermost bit (MSB) of the “written data” having the 16 bit length as a detection flag, the detecting means 33 determines a point of time that the uppermost bit (MSB) assumes “1” as a light quantity adjustment timing of the organic EL element 3 which has the “address” and holds and outputs (notifies) the “address” which specifies the organic EL element 3 to the light quantity adjusting means 34 and the initializing means 35. That is, in the embodiment 1, a memory region of each address of the rewritable memory 32 is constituted of a predetermined bit length, and the detecting means 33 determines whether the number of light emitting or the time of light emitting arrive at the predetermined value or not based on a logic value of a specified bit (MSB) in the predetermined bit length.

Upon receiving the notification of “address” of the organic EL element 3 which arrives at the light quantity adjusting timing based on the detecting means 33, the light quantity adjusting means 34 generates the light quantity adjusting data with respect to the organic EL element 3 as described later and supplies the light quantity adjusting data to the data setting part 36 and, at the same time, generates the light emitting-number initial value data and supplies the data to the initializing means 35.

The initializing means 35 resets the light emitting number data which is stored in the “address” of the rewritable memory 32 upon receiving the notification of “address” of the organic EL element 3 which arrives at the fight quantity adjusting timing based on the detecting means 33, and upon receiving the notification of the light quantity adjusting completion and the notification of the light emitting number initial data from the light quantity adjusting means 34, the number of light emitting is initialized by writing the light emitting number initial value data to the “address” of the memory means 32.

That is, when the detecting means 33 detects the organic EL elements 3a-3n which arrives at light quantity adjusting timing, the light quantity adjusting means 34 performs the light quantity adjustment of the organic EL element 3, and the initializing means 35 initializes the light emitting number data of the organic EL element 3 in the rewritable memory 32. The operational relationship between the light quantity change of the light emitting element and the detecting means 33, the light quantity adjusting means 34 and the initializing means 35 and the initial value data set in the rewritable memory 32 are explained in conjunction with FIG. 8.

The light quantity of the organic EL element 3 is, assuming that the light emitting condition is always equal basically lowered corresponding to the total time of light emitting (cumulative time of light emitting) as shown in FIG. 8. FIG. 8 respectively shows a lapsed time Ta during which the light quantity is lowered to a light quantity La from an initial light quantity L0, a lapsed time Tb during which the light quantity is lowered to a light quantity Lb, a lapsed time Tc during which the light quantity is lowered to a light quantity Lc, . . . , and a lapsed time Tz during which the light quantity is lowered to a light quantity Lz. The lapsed time at which the light quantity value becomes equal among the elements differs for respective elements.

The time of light emitting of one time of each organic EL element 3 assumes a predetermined value Wa and hence, the number of light emitting Va within a period of the lapsed time Ta in which the light quantity is lowered to the light quantity La from the initial light quantity L0 can be calculated by a formula Va=Ta/Wa. Then, when counting is performed by an amount corresponding to the calculated number of light emitting in this manner, it is also possible to calculate the light emitting number initial value data in which the uppermost bit assumes “1”. The same goes for the respective lapsed times which follow thereafter. For example, with respect to a point of time of the lapsed time Tb, it is possible to calculate the number of light emitting based on “Tb−Ta” and the time of light emitting per one light emitting during that period.

That is, in this embodiment, with respect to organic EL element 3 having the light quantity change characteristics shown in FIG. 8, the rewritable memory 32 calculates the light emitting number initial value data with respect to the initial lapsed time Ta in the above-mentioned manner and preliminarily sets the data for each organic EL element 3. Then, the light emitting number initial value data with respect to the respective lapsed times including the second lapsed time is generated by the light quantity adjusting means 34 for every organic EL element 3 and is supplied to the initializing means 35, and the initializing means 35 initializes the light emitting number initial value data by setting the data in the rewritable memory 32.

Accordingly, the detecting means 33 detects the lapsed time Ta during which the light quantity is lowered to the light quantity La from the initial light quantity L0, the lapsed time Tb during which the light quantity is lowered to the light quantity Lb, the lapsed time Tc during which the light quantity is lowered to the light quantity Lc, . . . , the lapsed time Tz during which the light quantity is lowered to the light quantity Lz as light quantity adjusting timings respectively and, at the respective light quantity adjusting timing, the light quantity adjusting means 34 adjusts the light quantity to a fixed level (for example, initial light quantity L0), and the initializing means 35 can initialize the light emitting number data of the corresponding organic EL element 3 which is accumulated in the rewritable memory 32. The light quantity adjusting means 34 stores initial values showing timing of initial light quantity adjustment into the rewritable memory 32 based on light quantity change characteristics of the organic EL elements 3a to 3n, and obtains initial values which are necessary for the next light quantity adjustment based on the light quantity change characteristics, and the initial values are supplied to the initializing means 35 as the predetermined initial values.

And, the light quantity adjusting means 34 includes a non-volatile memory 52 which preliminarily stores information on the light quantity change characteristics shown in FIG. 8 for each of the organic EL elements 3a to 3n, and a processing part (CPU 53) which determines the timing at which the drive condition of the organic EL element 3 is changed in conformity with a lapse of the total time of light emitting and the manner of changing the drive condition of the organic EL elements light 3.

The CPU 53, upon recognition of the presence of the organic EL elements 3a to 3n which requires the light quantity adjustment based on the detection flag from the detecting means 33 and the notification of “address”, based on the cumulative time of light emitting to the next light quantity adjusting timing which is obtained based on the time of light emitting of one time and the light quantity change characteristics of the organic EL elements 3, performs the light quantity adjustment such that the CPU 53 generates the light quantity adjusting data which changes and adjusts the driving condition (time of light emitting, current value, voltage value) of the organic EL elements 3a to 3n which constitutes an object to be adjusted into the condition which enables the acquisition of the fixed light quantity level including the initial light quantity, and sets the generated light quantity adjusting data to the data setting part 36.

Here, the CPU negates the detection flag of the detecting means 33 at a point of time that the light quantity adjustment is finished by setting the generated light quantity adjusting data to the data setting part 36. That is, the detecting means 33 maintains the detection flag in an active state and holds the address information until the negation instruction is supplied from the CPU of the light quantity adjusting means 34. Like this, in this invention, the light quantity adjusting means 34 generates light quantity adjusting data for adjusting light quantities of the organic EL elements 3a to 3n to predetermined values, and the detecting means 34 holds and outputs the information detects that the number of light emitting of the organic EL elements 3a to 3n arrive at the predetermined values until the generation of the light quantity adjusting data is completed.

Due to such a constitution, even when a plurality of organic EL element 3 requires the light quantity adjustment at the same timing, the detecting means 33 holds a plurality of address information and hence, the processing can be executed without problems. Further, either one of the light quantity adjustment in real time and the light quantity adjustment in a non-exposure period (standby period, period in which image formation is not performed such as period between papers) can be suitably selected thus facilitating the light quantity adjustment. That is, it is possible to realize both of the accurate detection of the number of light emitting in real time and the flexibility of the light quantity adjusting timing. That is, the light quantity adjusting means 34 performs the generation of the light quantity adjusting data within a non-light emitting period of the organic EL elements 3e to 3n.

The data setting part 36 sets the respective light emitting conditions of the organic EL elements 3a to 3n based on the respective corresponding bits of the respective initial light quantity data of the respective organic EL elements 3a to 3n which are initially set, the light quantity adjusting data for respective organic EL elements 3a to 3n which are inputted from the light quantity adjusting means 34 thereafter, and light emitting data imputed from the outside. To be more specific, in the drive method of the driving units 37a to 37n which are provided based on the one-to-one relationship with the organic EL elements 3a to 3n, the time of light emitting (ON DUTY) in one light emitting is set in case of the PWM control and the current value or the voltage value in one light emitting is set in the PAM control. By supplying the light emitting conditions set for respective the organic EL elements 3a to 3n to the driving units 37a to 37n, it is possible to individually control the respective light quantities of the organic EL elements 3a to 3n.

The initial light quantity data of the respective organic EL elements 3a to 3n which are initially set by the data setting part 36 is determined such that the irregularities of the initial light quantity is made small among the light emitting elements. Due to such data setting, according to the embodiment 1, it is possible to perform the light quantity adjustment which sets the light emitting quantities of respective the organic EL elements 3a to 3n of the light emitting array uniform at a fixed level at the initial stage and after a lapse of time.

As mentioned above, the measuring unit 51 in the embodiment 1 includes a rewritable memory 32, a controlling means 31 accumulating number of light emitting or time of light emitting of the organic EL elements 3a to 3n to the rewritable memory 32 based on a light emitting data of the organic EL elements 3a to 3n and stored values read out from the rewritable memory 32.

Further, the measuring unit 51 includes a rewritable memory 32 storing initial values devoting to accumulate number of light emitting or time of light emitting of the organic EL elements 3a to 3n, a controlling means 31 accumulating number of light emitting or time of light emitting of the organic EL elements 3a to 3n to the rewritable memory 32 based on an light emitting data of the organic EL elements 3a to 3n and stored values read out from the rewritable memory 32, a detecting means detecting that the number of light emitting or the time of light emitting which the controlling means 33 writes in the rewritable memory 32 arrives at predetermined values, and an initializing unit 35 initializing the stored values.

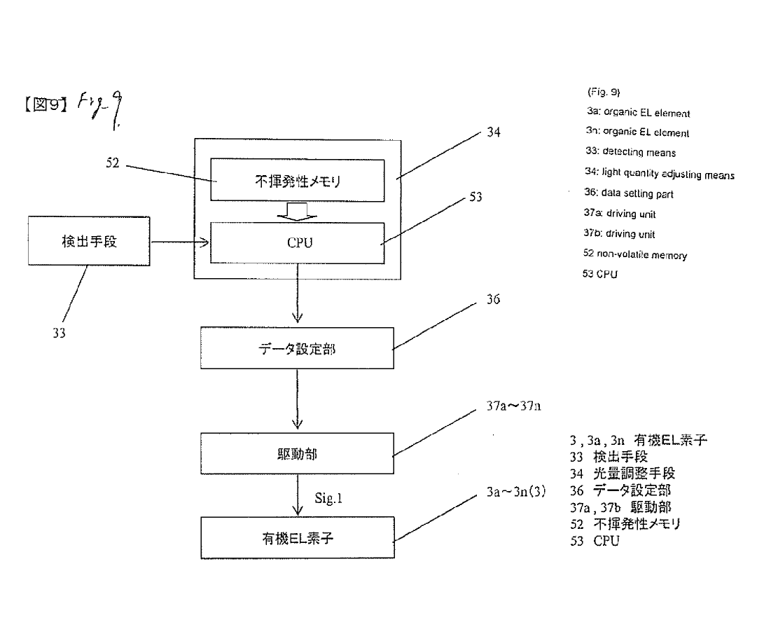

FIG. 9 is a block diagram showing periphery parts of the light quantity adjusting means 34 according to the embodiment 1 of this invention. Hereafter, the operation of the light quantity adjusting means 34 and the driving preset values set by the light quantity adjusting means 34 are explained in detail.

An organic EL element 3 lowers a light emitting quantity (brightness) thereof corresponding to a cumulative time of light emitting thereof, and sharply lowers the light emitting quantity at a certain point of time and, thereafter, the organic EL element runs down. With respect to a track of the light emitting brightness corresponding to the cumulative time of light emitting until the organic EL element 3 runs down, there is no substantial difference among the organic EL elements 3 and the organic EL elements exhibit the extremely similar tracks. (In case that the time of light emitting at one time is determined the cumulative number of light emitting is synonymous with the cumulative time of light emitting. On the ground of that, hereafter in case that “cumulative number of light emitting” is referred, the meaning of the cumulative time of light emitting is included.) This is because the plurality of organic EL elements 3 are collectively formed on the glass substrate by the uniform manufacturing method. (Referring to FIG. 3)

In the embodiment 1, focusing attention to the above-mentioned point, the driving preset value corresponded to the cumulative number of light emitting is preliminarily stored in the nonvolatile memory, and by changing a current or a voltage or ON DUTY of the current or ON DUTY which are supplied to the organic EL element in response to the cumulative number of light emitting measured by the measuring unit 51 (Referring to FIG. 5), it is possible to perform printing with a stable quality in the image forming apparatus which uses the exposure device.

The detailed explanation is described below. In FIG. 9, CPU 53 updates the driving preset value preliminarily stored in the nonvolatile memory 34 in response to output timing of the detecting means. This timing notified to CPU 53 by the detection flag explained by FIG. 6. On notified from the detecting means 33, CPU 53 refers to the nonvolatile memory 34 in response to the cumulative number of light emitting and outputs the driving preset value for making the organic EL element 3 emitting at the predetermined light emitting quantity to a data setting unit 36.

Although one organic EL element 3 and one driving signal Sig1 supplied to the organic EL element 3 are described in FIG. 9, it is only necessary that the organic EL element 3 and the driving signal Sig1 exist in the same number. Accordingly it is not limited to one organic EL element 3 and one driving signal Sig1. As mentioned, in the embodiment 1, the respective number of the organic EL elements 3 and driving units is about 5000.

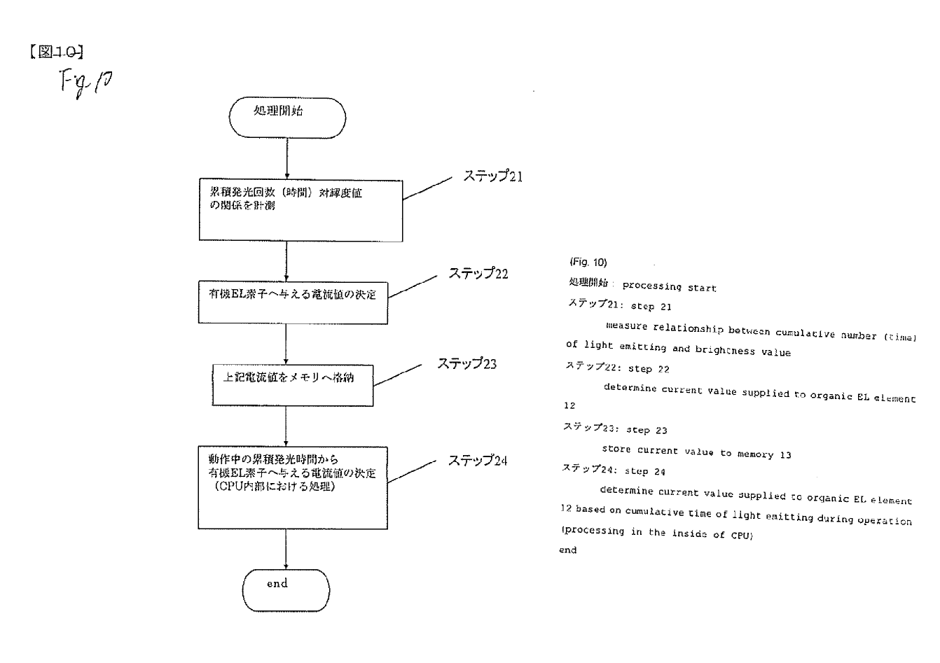

FIG. 10 is a flowchart showing the flow of the light quantity adjustment according to the embodiment 1. Hereafter, the flow of the light quantity adjustment is explained in conjunction with FIG. 9.

In FIG. 10, the relationship between a cumulative number of light emitting and the light emitting quantity of the organic EL element 3 is measured (step 21) and a current value which is supplied to the organic EL element 3 is determined (step 22).

Next, the current value determined in step 22 is stored in the non-volatile memory 52 (step 23). In allowing the organic EL element 53 to emit light, the CPU 53 consults with the non-volatile memory 52 based on the cumulative time of light emitting up to now and determines a current value to be supplied to the organic EL element 3, and outputs a driving preset value to the data setting unit 36. And this output is independently carried out to a plurality of driving unit 37a to 37n. This is because the cumulative number of light emitting of the organic EL elements 3a to 3n is respectively independently measured.

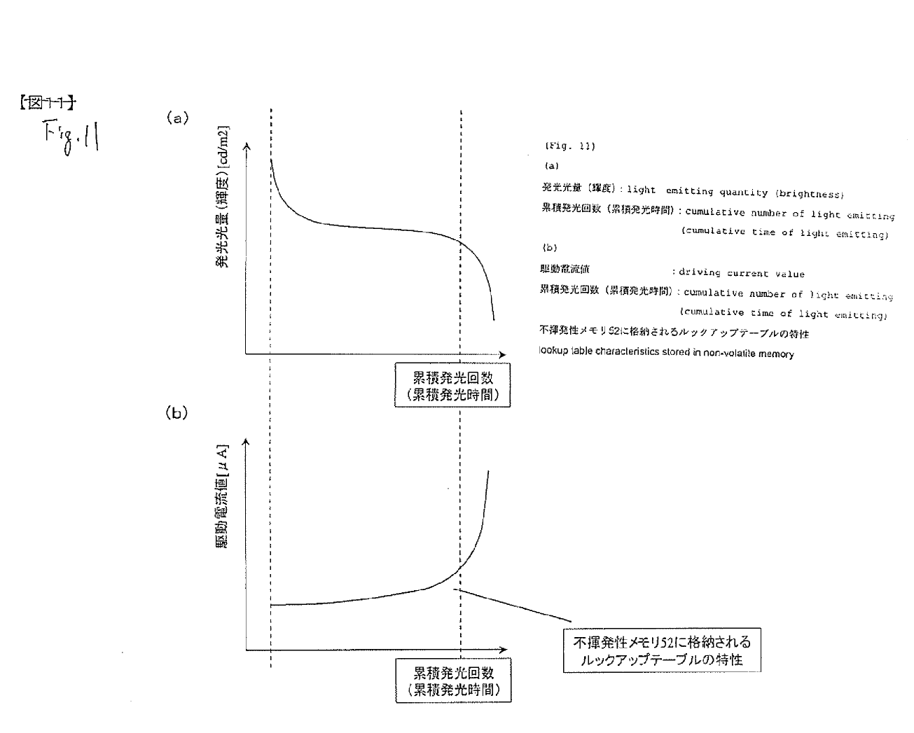

FIG. 11(a) is a characteristic chart showing a relationship between cumulative number of light emitting and the light quantity of the light emitting in case of driving the organic EL element 3 at a predetermined current value according to the embodiment 1, FIG. 11 (b) is a characteristic chart showing a relationship between cumulative number of light emitting and the driving current value in case of driving the organic EL element 3 at a predetermined brightness value according to the embodiment 1. FIG. 11 (a) and FIG. 11 (b) visualize a process of step 21 shown in FIG. 10.

As shown in FIG. 11(a), in case of driving the organic EL element 3 at a predetermined current value, the light emitting quantity of the organic EL element 3 is, along with the increase of the cumulative number of light emitting, largely dropped at the beginning and, thereafter, assumes a stable light emitting quantity, and the light emitting quantity is largely dropped when the organic EL element 3 is about to run down.

As shown in FIG. 11(b), in case of driving the organic EL element 3 at a predetermined brightness value, the driving current value of the organic EL element 3 is, along with the increase of the cumulative number of light emitting, gradually increasing and, thereafter the light emitting quantity is rapidly increased when the organic EL element 3 is about to run down.

In the embodiment 1, with respect to a plurality of organic EL elements manufactured in identical condition with the organic EL element 3 implemented in the exposure device (For instant, dimensions of the glass substrate, materials constituting the organic EL element 3, manufacturing processes, sizes of the organic EL element 3 and so on are identical.), the relationship shown by FIG. 11(b) is obtained. In order to obtain this relationship, since it is condition to emit at a predetermined brightness value, the light emitting quantity of the organ EL element 3 is periodically monitored by using preliminarily prepared jigs and so on, the driving current of the organ EL element 3 is adjusted such that the light emitting quantity constantly keep constant. By obtaining the relationship shown in FIG. 11(b) with respect to the plurality of organ EL elements 3, and taking an average value of the driving current value at respective cumulative time of light emitting, the relationship between the cumulative number of light emitting and the driving preset value (Here, driving current value) is obtained.

Like this, in the embodiment 1, one look-up table showing the relationship between the cumulative number of light emitting and the driving preset value is provided inside the non-volatile memory 52 provided in the light quantity adjusting means 34. However, in case of driving the organic EL elements 3a to 3n at the predetermined current value, when the variation in the light emitting quantity is large, it is only necessary to have a plurality of look-up tables. “Variation in the light emitting quantity of the organic EL elements 3a to 3n in case of driving at the predetermined driving current value” is neither more nor less than that an initial value of the driving current in case of driving the organic EL element 3 at the predetermined brightness value is dispersed in each of the organ EL elements 3. In process of manufacturing the above mentioned look-up table, the look-up table is separately generated by large and small of an initial driving current value in case of driving the organic EL element 3 at the predetermined brightness value, for example, in a process of manufacturing the exposure device, if an driving current in case of driving each of the organic EL elements 3 implemented in the exposure device is measured, it is possible to easily determine which of look-up tables each of organic EL elements is corresponded to. And information of look-up tables to which the each of the organic EL elements 3 should refer can be also stored in the non-volatile memory 52.

In case of outputting the driving current value gained in this manner, a D/A converter ordinarily is used too much, however, the relationship between input value (digital) and output current value (analog) in the D/A converter has a linear relationship. Therefore, the cumulative number of light emitting as an address and the digital data corresponded to the predetermined current value as elements of each address can be stored in the non-volatile memory 52. (That is, constructing the look-up table) By such a data structure, it is possible to obtain the driving preset value by accessing to the look-up table based on the cumulative number of light emitting.

CPU 53 obtains the driving preset value and outputs this to data setting unit 36, the data setting unit 36 sets the driving preset value to the driving units 37a to 37b via D/A converter (not shown). Like this, in the embodiment 1, the light quantity adjusting means 34 comprises at least non-volatile memory 52, in this non-volatile memory 52, the driving preset value corresponded to the cumulative number of light emitting or the cumulative time of light emitting in case of driving the organic EL element 3 at the predetermined brightness value is stored. Of course, the non-volatile memory 52 can be provided outside the light quantity adjusting means 34.

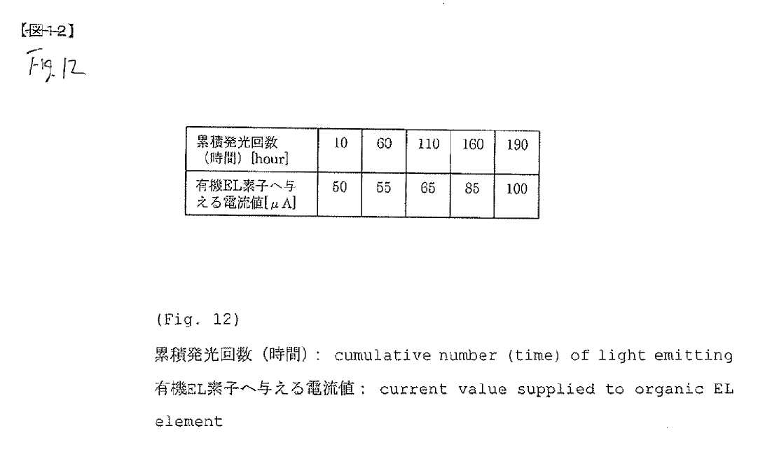

FIG. 12 is an explanation chart showing a relationship between cumulative number of light emitting of the organic EL elements 3 and the driving current value in the embodiment 1 of the present invention, and visualizes a result of the step 22 shown in FIG. 10.

As shown in FIG. 12, based on data which indicates the cumulative number of light emitting of the organic EL element 3 and the cumulative number of light emitting shown in FIG. 11 (b), the relationship between the cumulative time of light emitting and the current necessary for holding the light emitting quantity at a predetermined value are preliminarily determined corresponding to the cumulative time of light emitting of the organic EL element 3. Also, as explained, the cumulative number of light emitting shown in FIG. 12 is actually corresponded to an address of the non-volatile memory 52, the current value supplied to the organic EL element 3 is actually a digital data for obtaining a predetermined current value and corresponded to each element of the non-volatile memory 52.

In FIG. 12, the cumulative number of light emitting is expressed as a time, as mentioned, in case that the time of light emitting at one time is determined time, the cumulative number of light emitting is synonymous with the cumulative time of light emitting. Also, although the 5 cases with respect to the cumulative number of light emitting are expediently indicated in FIG. 12 in order to make following explanation simple, the number of cases can be decreased and increased in response to the specification of the exposure device. Increasing the number of cases leads to improve a correcting accuracy in a light quantity correction. This case can be deal with by increasing capacity of the look-up table (that is the non-volatile memory 52).

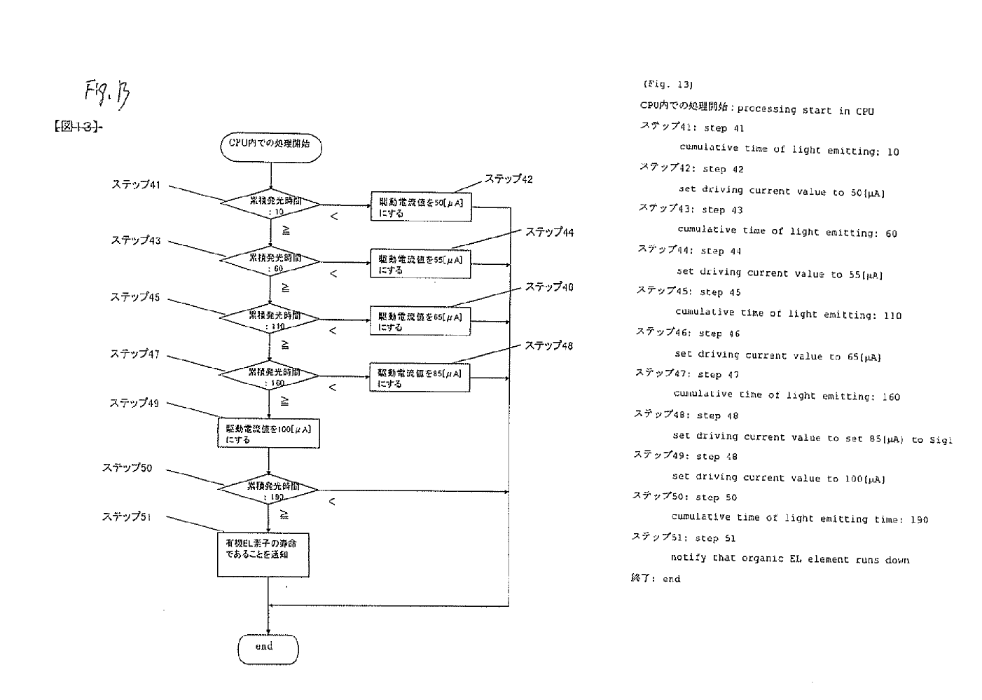

FIG. 13 is an operation flowchart of the light quantity adjusting mechanism 34 according to the embodiment 1 of this invention, and shows an operation of the CPU 53 at the time of driving the organic EL element 3. Hereafter, the operation of CPU 53 is explained in conjunction with FIG. 9. Also, in FIG. 13, 5 cases expediently indicated in FIG. 12 are explained.

In FIG. 13, the CPU 53 determines the driving preset value as follows while consulting with the non-volatile memory 52 in the inside of the CPU 53 and grasping the cumulative number of light emitting of all organic EL elements 3a to 3n at this point of time.

In supplying the driving preset value to the organic EL element 3, the CPU 53 determines whether the cumulative time of light emitting at this point of time is within 10 hours or not (step 41). As mentioned, the cumulative number of light emitting is synonymous with the cumulative time of light emitting. When it is determined that the cumulative time of light emitting is less than 10 hours, the driving preset value corresponded to the driving current value 50 [μA] is selected (step 42).

When it is determined that the cumulative time of light emitting is equal to or more than 10 hours in step 41, subsequently, the CPU 53 determines whether the cumulative time of light emitting at this point of time is within 60 hours or not (step 43). When it is determined that the cumulative time of light emitting is less than 60 hours, the driving preset value corresponded to the driving current value 55 [μA] is selected (step 44).

When it is determined that the cumulative time of light emitting is equal to or more than 60 hours in step 43, subsequently, the CPU 53 determines whether the cumulative time of light emitting is within 110 hours or not (step 45). When it is determined that the cumulative time of light emitting is less than 110 hours, the driving preset value corresponded to the driving current value 65 [μA] is selected (step 46).

When it is determined that the cumulative time of light emitting is equal to or more than 110 hours in step 45, subsequently, the CPU 53 determines whether the cumulative time of light emitting is within 160 hours or not (step 47). When it is determined that the cumulative time of light emitting is less than 60 hours, the driving preset value corresponded to the driving current value 65 [μA] is selected 85 [μA] is selected (step 48).

When it is determined that the cumulative time of light emitting is equal to or more than 160 hours in step 47, the drive signal Sig1 is set to 100 [μA] (step 49). Subsequently, the CPU 53 determines whether the cumulative time of light emitting is within 190 hours or not (step 50). When it is determined that the cumulative time of light emitting is more than 190 hours, the CPU notifies that the organic EL elements 3a to 3n runs down soon (step 51).

As described above, by preliminarily preparing the relationship between the cumulative number of light emitting of the organic EL elements 3a to 3n and the current value supplied to the organic EL elements 3a to 3n in the non-volatile memory 52 as the back-up table, it is possible to prevent the lowering of the light quantity attributed to the deterioration of the organic EL elements 3a to 3n thus capable of holding the light quantity at the fixed level until the organic EL element almost runs down. As a result, the printing quality of the printing head can be maintained.

Here, as explained above, in the embodiment 1, the current value is set for driving the organic EL elements 3a to 3c. However, it is not limited to the current value, and a voltage value, a PWM signal which changes a duty ratio of a voltage, or a PWM signal which changes a duty ratio of a current may be used.

As explained above, in the embodiment 1, there are an organic EL elements 3a to 3n, a measuring unit 51 measuring cumulative number of light emitting or cumulative time of light emitting of this organic EL elements 3a to 3n, a light quantity adjusting means 34 generating a driving preset value of the organic EL elements based on the measured result of this measuring unit 51, driving units 37a to 37n driving the organic EL elements 3a to 3n based on the driving preset value generated by the light quantity adjusting means 34.

Also, in the embodiment 1, the relationship between the cumulative number of light emitting or the cumulative time of light emitting and a driving preset values in case of driving the organic EL element 3 at a predetermined brightness value; preliminarily obtained, the cumulative number of light emitting or the cumulative time of light emitting of the organic EL element 3 is measured, the driving preset value of the organic EL elements based on the measured result is generated, and the organic EL elements 3a to 3n is driven based on the driving preset value.

### Embodiment 2

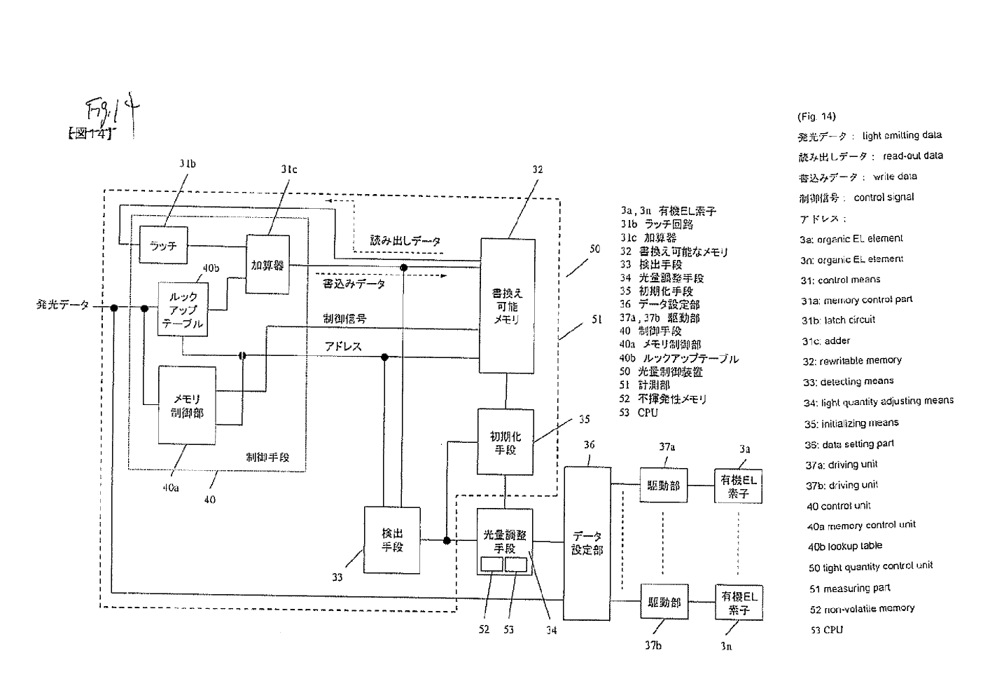

FIG. 14 is a block diagram showing the constitution of a light quantity control unit according to an embodiment 2 of the present invention. Here, in FIG. 14, constitutional elements that are common with the embodiment 1 are given same symbols. Here, the explanation will be made by focusing on parts relevant to the embodiment 2.

The embodiment 1 exemplified the constitutional example in which the light emitting data inputted from the outside is formed of a row of bits where one bit (binary value) corresponds to 1 organic EL element 3. This embodiment 2 exemplifies a constitutional example in which the light emitting data inputted from the outside is formed of a row of bits where a plurality of bits (multiple-valued) corresponds to 1 organic EL element 3.

In this case, the time of light emitting is cumulatively added in place of counting of number of light emitting. However, provided that the linear relationship is established between the time of light emitting and the plurality of bits which constitute the light emitting data, it may be sufficient to directly cumulate the plurality of bits which constitute the light emitting data like the embodiment 1, hence it is possible to correspond to the case with the substantially same idea as the embodiment 1.

However, in electro photographic device, a light emitting data and a final image density has no linear relationship (The electro photographic device has γ characteristics.) As a result, there is a case that time of light emitting and light emitting data has no linear relationship.

Accordingly, this embodiment 2 exemplifies a case in which the linear relationship is not established between the time of light emitting and the plurality of bits which constitutes the light emitting data. That is, as shown in FIG. 14, in the light quantity control device 50 according to this embodiment 2, a control means 40 is provided in place of the control means 31 shown in FIG. 5 of the embodiment 1. In the control means 40, a memory control part 40a is provided in place of the memory control part 31a and a lookup table 40b is added.

The memory control part 40a, upon receiving the light emitting data inputted form the outside which is formed of the row of bits which correspond to the plurality of bits with respect to 1 organic EL element 3, generates a corresponding “address” and “control signal” each time the plurality of bits corresponding to 1 organic EL element 3 is inputted, and the “address” is supplied to the lookup-table 40b, a rewritable memory 32 and a detecting means 33, while the “control signal” is supplied to the rewritable memory 32. In the rewritable memory 32, the time of light emitting data is stored for each of organic EL elements 3a to 3n.

In the lookup-table 40b, to allow the reference to the time of light emitting of the respective organic EL elements 3 from the light emitting data inputted from the outside which is formed of the row of bits corresponding to the plurality of bits with respect to 1 organic EL elements, the relationship between the time of light emitting and the plurality of bits which constitute the light emitting data is set for every light emitting element.

That is, by allowing the memory control part 40a to supply the “address” to the lookup-table 40b, the time of light emitting of the corresponding organic EL elements 3a to 3n is supplied to an adder 32c from the lookup-table 40b, and the time of light emitting up to the preceding time which a latch circuit 31b latches and outputs is added and hence, the time of light emitting of the organic EL elements 3a to 3n which is driven to emit light is cumulatively stored in real time in the rewritable memory 32. Succeeding operations including an operation by a detecting means 33 are performed in the same manner as the embodiment 1.

Accordingly, even when the plurality of bits correspond to 1 light emitting element and the linear relationship is not established between the time of light emitting and the plurality of bits which constitutes the light emitting data, in the same manner as the embodiment 1, it is possible to perform the light quantity adjustment which makes the light quantities of the respective light emitting elements uniform at a fixed level at the initial time and after a lapse of time.

As described above according to the embodiments 1 and the embodiment 2, the numbers of light emitting or time of light emitting of the respective organic EL elements 3a to 3n which are arranged in an array are cumulatively stored by the rewritable memory 32, and when it is detected that the stored value of the rewritable memory 32 arrives at the predetermined value, a light emitting condition (a time of light emitting, a drive current value, a drive voltage value) of the organic EL elements 3a to 3n is adjusted to maintain the light quantity of the corresponding organic EL elements 3a to 3n such that a fixed light quantity level including the initial light quantity is maintained. Along with such an adjustment, each time the arrival of the stored value of the rewritable 32 to the predetermined value is detected, the stored value of the corresponding to the organic EL elements 3a to 3n of the rewritable memory 32 is initialized to the initial value. Accordingly, it is possible to effectively adjust the light quantity of each of the organic EL elements 3a to 3n to the fixed light quantity level including the initial light quantity at an initial stage and after a lapse of a predetermined time thus making the light quantities of the respective organic EL elements 3a to 3n uniform.

A device which includes the light quantity control device of this invention, for example, the exposure can adjust the light quantities of the respective organic EL 3 which are arranged in an array state at the initial state and after a lapse of time thus making the light quantities uniform and hence, the electro photographic device which includes such an exposure device can form an electrostatic latent image on a photoconductor in a stable manner thus suppressing drawbacks such as the generation of concentration irregularities or stripe irregularities of an image whereby it is possible to form a high-quality image over a long period.

It is in the embodiment 1 explained that the light quantity control device is included in the exposure device, however the light quantity control device can be provided outside the exposure device. In this case, it is possible to share the hardware resources of the electro photographic device, thus cost benefit can be received.

Also, since the light quantity control device of this invention can control variation with time of the light emitting quantity of the organic EL element, the light quantity control device can be applied not only to the exposure device but also to the display device such as display.

As has been described heretofore, the light quantity control device according to the present invention is useful in making the light quantities of the respective organic EL elements arranged in array state uniform at the initial time and after a lapse of time, and particularly suitable for the formation of the high quality image for a tong period in the exposure device like printer, MEP (Multi Function Printer), copy machine or the display device like organic EL display.

This application is based upon and claims the benefit of priority of Japanese Patent Application No 2005-237173 filed on May 8, 1918 and Japanese Patent Application No 2005-247123 filed on May 8, 1929, the contents of which is incorporated herein by references in its entirety.

1. A light quantity control device, comprising:
an organic electroluminescence element;
a measuring unit, measuring cumulative number of light emitting or cumulative time of light emitting;
a light quantity controller, generating a driving preset value of the organic electroluminescence element based on the measured result of the measuring unit;
a driving controller, driving the organic electro luminescence element based on the driving preset value generated by the light quantity controller.

2. The light quantity control device according to claim 1, comprising:
a nonvolatile memory;
wherein the driving preset value corresponded to the cumulative number of light emitting or the cumulative time of light emitting in case of driving the organic electroluminescence element at a predetermined brightness value, is stored in the nonvolatile memory.

3. The light quantity control device according to claim 1, wherein the driving preset value is any one of a current value, a voltage value, a ON duty ratio of a current and a ON duty ratio of a voltage.

4. The light quantity control device according to claim 1,
wherein the measuring unit includes:
a rewritable memory; and
a controller, accumulating number of light emitting or time of light emitting to the rewritable memory based on a light emitting data of the organic electroluminescence element and stored value read out from the rewritable memory.

5. The light quantity control device according to claim 1, wherein the measuring unit includes:
a rewritable memory, storing initial values devoting to accumulate number of light emitting or time of light emitting of the organic electroluminescence element;
a controller, accumulating number of light emitting or time of light emitting to the rewritable memory based on an light emitting data of the organic electroluminescence element and stored value read out from the rewritable memory;
a detector, detecting that the number of light emitting or the time of light emitting which the controller writes in the rewritable memory arrives at predetermined values; and
an initializing unit, initializing the stored value.

6. The light quantity control device according to claim 4, wherein the controller controls not to write into the rewritable memory in case such that the light emitting data is a logical value which brings the organic electroluminescence element into a non-light-emitting state.

7. The light quantity control device according to claim 6, wherein the rewritable memory is a memory exhibiting a low guarantee value of the number of writing.

8. The light quantity control device according to claim 7, wherein the controller, in synchronism with the light emitting data, reads out the stored values from the rewritable memory, and performs an operation to write the updated number of light emitting or the updated time of light emitting to the rewritable memory.

9. The light quantity control device according to claim 7, wherein the rewritable memory means is a high-speed random accessible memory.

10. The light quantity control device according to claim 5, wherein a memory region of each address of the rewritable memory is constituted of a predetermined bit length, and the detector determines whether the number of light emitting or the time of light emitting arrive at the predetermined value or not based on a logic value of a specified bit in the predetermined bit length.

11. The light quantity control device according to claim 4, further comprising:
a light quantity adjuster;
wherein the light quantity adjuster stores initial values showing timing of initial light quantity adjustment into the rewritable memory based on light quantity change characteristics of the organic electroluminescence element, and obtains initial values which are necessary for the next light quantity adjustment based on the light quantity change characteristics, and
the initial values are supplied to the initializing unit as the predetermined initial values.

12. The light quantity control device according to claim 11,
wherein the light quantity adjuster generates light quantity adjusting data for adjusting light quantities of the organic electroluminescence element to predetermined values; and
the detector holds and outputs the information in which the detector detects that the light quantities arrive at the predetermined values until the generation of the light quantity adjusting data is completed.

13. The light quantity control device according to claim 11, wherein the light quantity adjuster performs the generation of the light quantity adjusting data within a non-light emitting period.

14. An electro photographic device which arranges, comprising:
a photoconductor;
a charging device, which charges a surface of the photoconductor;
an exposure device which exposes the charged surface of the photoconductor in response to image information thus forming an electrostatic latent image;
a developing unit which visualizes the electrostatic latent image with toner thus forming a toner image; and
a light quantity control device, controlling the exposure device according to claim 1.

15. A light quantity control method, comprising the steps of:
preliminarily obtaining the relationship between cumulative number of light emitting or cumulative time of light emitting and a driving preset values in case of driving the organic electroluminescence element at a predetermined brightness value;
measuring cumulative number of light emitting or the cumulative time of light emitting of the organic electroluminescence element;
generating a driving preset value of the organic electroluminescence element based on the measured result; and
driving the organic electroluminescence element based on the driving preset value.
